(19) United States
(12) Patent Application Publication
(10) Pub. No.: US 2012/0218222 A1
(43) Pub. Date: Aug. 30, 2012

(54) CANCELLING TOUCH PANEL OFFSET OF A TOUCH PANEL SENSOR

(75) Inventors: Guozhong Shen, San Jose, CA (US); Ozan E. Erdogan, Saratoga, CA (US); Syed Mahmud, Dublin, CA (US)

(73) Assignee: MAXIM INTEGRATED PRODUCTS, INC., Sunnyvale, CA (US)

(21) Appl. No.: 13/402,485

(22) Filed: Feb. 22, 2012

Related U.S. Application Data
(60) Provisional application No. 61/446,944, filed on Feb. 25, 2011.
(60) Provisional application No. 61/495,149, filed on Jun. 9, 2011.

(51) Int. Cl. G06F 3/044

(52) U.S. Cl. 345/174

(57) ABSTRACT

A touch panel sensor system for increasing the dynamic range of the system is disclosed. The touch panel sensor system comprises a sensor driver module for driving one or more sensors of a touchscreen and an offset cancellation driver module for driving an offset cancellation module. The signals generated by the sensors and the offset cancellation module are coupled to a measuring module at a node (N1). The signal generated by the offset cancellation drivers can be adjusted so that the waveform characteristics (e.g., amplitude and phase) of the signal generated by the offset cancellation drivers in combination with the offset cancellation module can at least partially cancel parasitic and sensor capacitances (Cₛ) of the sensors of the touch panel. A measuring module may then detect a touch event capacitance (C_{Δ}) at the node (N1).

### CROSS-REFERENCE TO RELATED APPLICATIONS

The present application claims the benefit under 35 U.S.C. §119(e) of U.S. Provisional Application Ser. No. 61/446,944, entitled METHOD AND APPARATUS FOR CANCELLING TOUCH PANEL OFFSET OF A TOUCHSCREEN SENSOR, filed on Feb. 25, 2011; and U.S. Provisional Application Ser. No. 61/495,149, entitled METHOD AND APPARATUS FOR CANCELLING TOUCH PANEL OFFSET OF A TOUCHSCREEN SENSOR, filed on Jun. 9, 2011. U.S. Provisional Application Ser. Nos. 61/446,944 and 61/495,149 are herein incorporated by reference in their entireties.

### BACKGROUND

A touch panel is a human machine interface (HMI) that allows an operator of an electronic device to provide input to the device using an instrument such as a finger, a stylus, and so forth. For example, the operator may use his or her finger to manipulate images on an electronic display, such as a display attached to a mobile computing device, a personal computer (PC), or a terminal connected to a network. In some cases, the operator may use two or more fingers simultaneously to provide unique commands, such as a zoom command, executed by moving two fingers away from one another; a shrink command, executed by moving two fingers toward one another; and so forth.

A touch screen is an electronic visual display that incorporates a touch panel overlying a display to detect the presence and/or location of a touch within the display area of the screen. Touch screens are common in devices such as all-in-one computers, tablet computers, satellite navigation devices, gaming devices, and smartphones. A touch screen enables an operator to interact directly with information that is displayed by the display underlying the touch panel, rather than indirectly with a pointer controlled by a mouse or touchpad. Capacitive touch panels are often used with touch screen devices. A capacitive touch panel generally includes an insulator, such as glass, coated with a transparent conductor, such as indium tin oxide (ITO). As the human body is also an electrical conductor, touching the surface of the panel results in a distortion of the panel's electrostatic field, measurable as a change in capacitance.

### SUMMARY

A touch panel sensor system that furnishes increased dynamic range is disclosed. The touch panel sensor system comprises a sensor driver module for driving one or more sensors of a touchscreen and an offset cancellation driver for driving an offset cancellation module. The signals generated by the sensors and the offset cancellation module are coupled to a measuring module at a node (N1). The signal generated by the offset cancellation drivers can be adjusted so that the waveform characteristics (e.g., amplitude and phase) of the signal generated by the offset cancellation drivers, in combination with the offset cancellation module, can at least partially cancel the sensor capacitances (Cₛ) of the sensors of the touch panel. For example, the signal generated by the offset cancellation drivers can at least substantially cancel (e.g., a majority part of) the sensor capacitances (Cₛ). A measuring module may then detect a touch event capacitance (C_{Δ}) at the node (N1).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. The use of the same reference numbers in different instances in the description and the figures may indicate similar or identical items.

FIG. 1A is a block diagram illustrating a touch panel sensor system in accordance with an example implementation of the present disclosure.

FIG. 1B is a circuit diagram illustrating the touch panel sensor system shown in FIG. 1A.

FIG. 2 is a flow diagram illustrating an example method for dynamically adjusting a touch panel sensor system to cancel touch panel offset according to an example implementation of the present disclosure.

### DETAILED DESCRIPTION

### Overview

Capacitive touch panels detect capacitance changes caused by a user touching the screen (touch event capacitance (C_{Δ})), the sensor capacitance (Cₛ) of each sensor, and other environmental (e.g., parasitic) capacitances. These sensor and parasitic capacitances can change from sensor to sensor and from touch panel to touch panel. In one or more implementations, the touch event capacitance (C_{Δ}) is about ten percent to fifteen percent (10% to 15%) of the sensor capacitance (Cₛ) (e.g. C_{Δ}=1 pico-Farad and Cₛ=10 pico-Farads). Thus, the charge transfer schemes/integrators used to measure the touch panel capacitance typically must be able to accommodate a greater amount of capacitance that represents the touch event capacitance (C_{Δ}) in addition to the sensor capacitance (Cₛ) and the parasitic capacitances (e.g., C_{Δ}+Cₛ+parasitic capacitance). This larger capacitance may prevent the use of larger gain circuits designed to generate improved signal to noise ratios as well as requiring inefficient use of analog to digital converter (ADC) range. Some charge transfer schemes/integrators may include an integrating capacitor that is sufficiently large so as to not be saturated by the total capacitance/charge received from the sensors. However, using large integrating capacitors increases the cost and the size of components, as well as reducing the gain and the resolution of the measurement system.

Accordingly, a touch panel sensor system is described that includes a capacitance-to-voltage converter circuit to minimize environmental (e.g., parasitic) and sensor capacitances, which may improve the dynamic range of the touch panel sensor system. In one or more implementations, the touch panel sensor system includes a sensor driver module for driving one or more sensors of a touch panel and an offset cancellation driver for driving an offset cancellation module. The signals output from the sensors and the offset cancellation module are coupled to a measuring module at a common node (N1). The driving signal generated by the offset cancellation drivers can be adjusted so that the amplitude and phase of the driving signals produced by the offset cancellation drivers, in combination with the offset cancellation module, can at least substantially cancel the parasitic and sensor capacitances (Cₛ) of the sensors. For example, the signal generated by the offset cancellation drivers can at least substantially cancel (e.g., a majority part of) the sensor capacitances (Cₛ). Thus, the measuring module may detect at least substantially only the touch event capacitance (C_{Δ}) at the node (N1). Thus, the touch panel sensor system may utilize a small integrating capacitor, which lowers cost, decreases system size, and improves the dynamic range of the touch panel sensor system.

Example Implementations

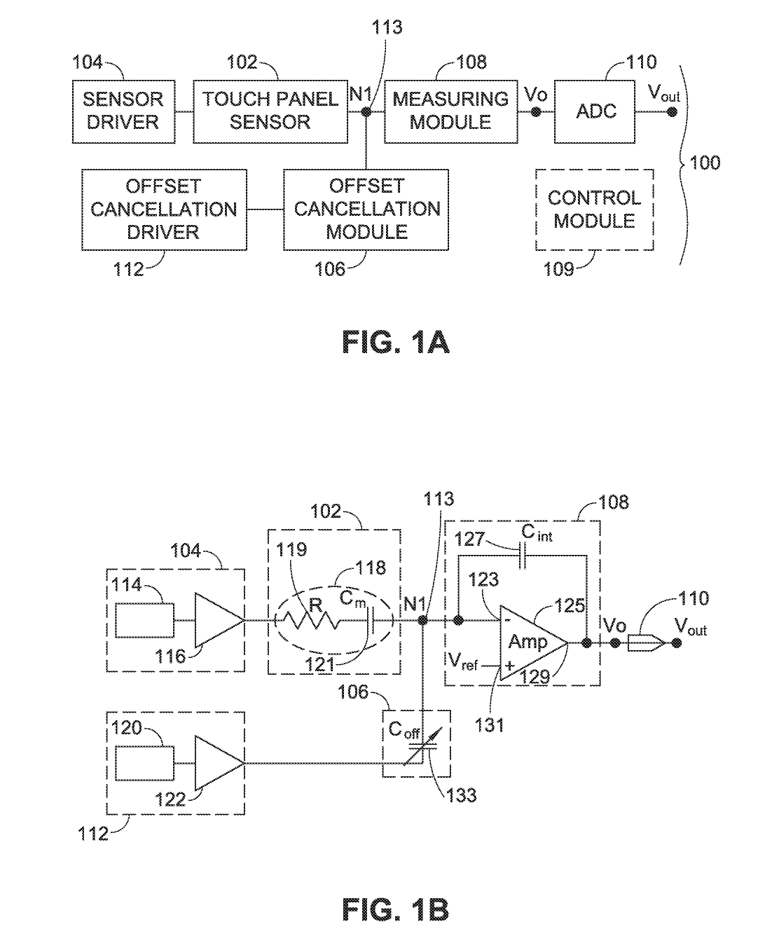

FIG. 1A illustrates a touch panel sensor system 100 in accordance with an example implementation of the present disclosure. The touch panel sensor system 100 includes a touch panel sensor 102, a sensor driver module (e.g., sensor driver 104), an offset cancellation module 106, an offset cancellation driver module (e.g., offset cancellation driver 112), a measuring module 108, and an analog-to-digital converter (ADC) 110. Viewed together, the touch panel sensor 102, the sensor driver 104, the offset cancellation module 106, the offset cancellation driver, the measuring module 108, and the ADC 110 comprise a capacitance-to-voltage converter circuit. In implementations, the touch panel sensor system 100 may include a greater number or a lesser number of the above components in accordance with the requirements of the system 100 (e.g., space restraints, functionality requirements, and so forth). The touch panel sensor system 100 may also include additional components, such as multiplexers, controllers, or the like. For example, in some implementations, one or more multiplexers may be coupled to multiple sensors of the touch panel sensor 102 and selectively output sensed capacitance signals (Cₘ) from the selected sensors to the measuring module 108. Moreover, in some implementations, the sensor driver 104, the measuring module 108, the ADC 110, the offset cancellation driver 112, and the offset cancellation module 106 may be fabricated onto a single integrated circuit chip (IC) device (e.g., each component is fabricated on a single die). In other implementations, one or more of the components described above may be external to the IC (e.g., fabricated on another IC device).

The sensor driver 104 is coupled (e.g., electrically connected) to one or more sensors of the touch panel sensor 102 so that the sensor driver 104 outputs a drive signal having waveform characteristics that drives the coupled sensors. The sensor driver 104 may be a digital to analog converter (DAC). However, in some implementation, the sensor driver 104 may comprise other suitable devices capable of producing driving signals. The touch panel sensor 102 is coupled to the output of the sensor driver 104 and the input of the measuring module 108. As a result, when the sensor driver 104 generates a signal having waveform characteristics that drives one or more of the sensors on the touch panel sensor 102, the charge from the sensors is transferred to the input of the measuring module 108 at the node (N1) 113.

The offset cancellation driver 112 is coupled to the offset cancellation module 106 and generates an offset cancellation signal having waveform characteristics that drive the offset cancellation module 106. As illustrated, the offset cancellation driver 112 is a DAC. However, in implementations, the offset cancellation driver 112 may comprise suitable device capable of generating driving signals. Moreover, one or more components of the sensor driver 104 may be shared by the offset cancellation driver 112. The offset cancellation module 106 is coupled to the output of the offset cancellation driver 112 and the input of the measuring module 108. As a result, when the offset cancellation driver 112 outputs an offset cancellation signal that drives the offset cancellation module 106, the charge from the offset cancellation module 106 is transferred to the input of the measuring module 108 at node (N1) 113. Thus, the charge output from the sensors (e.g., sensor driver 104 and touch panel sensor 102) and the charge output from the offset cancellation module 106 is combined at the node (N1) 113, and input to the measuring module 108. The charge output from the offset cancellation module 106 may be utilized to at least substantially cancel parasitic capacitance and/or sensor 108 capacitance at the node (N1) 113.

The output of the measuring module 108 is coupled to the input of the ADC 110. Thus, the capacitance charge measured at the node (N1) 113 may be transmitted as an analog voltage value (Vₒ) to the ADC 110. In one or more implementations, the measuring module 108 may comprise an integrator device. However, in another implementations, the measuring module 108 may comprise any device (e.g., circuitry) capable of receiving a capacitance and outputting a voltage (Vₒ) that corresponds to the capacitance. The output of the ADC 110 (e.g., output voltage (Vₒᵤₜ)) outputs from the system 100 to a device that may be controlled by the touch panel sensor system 100. In an implementation, a control module 109 (e.g., control logic circuitry) may be coupled to the touch panel sensor 102, the sensor driver 104, the offset cancellation driver 112, the ADC 110, the measuring module 108, and the offset cancellation module 106 so that the control logic may control the operation of the system 100. For example, as described herein, the control module 109 is configured to control various aspects of the offset cancellation driver 112, the offset cancellation module 106, and the like. In another implementation, the system 100 may be configured as an open loop system.

FIG. 1B illustrates a specific implementation of the touch panel sensor system 100 shown in FIG. 1A. In FIG. 1B, the sensor driver 104 comprises a sensor DAC 114 coupled to a buffer 116. The buffer 116 is configured to buffer the signal generated by the sensor DAC 114 and outputs the buffered drive signal to the sensor 118 of the touch panel sensor 102 to drive the sensor 118. In implementations, the sensor DAC 114 may generate a signal having waveform characteristics represented by the equation:

A1·sin(ωt), EQN. 1

where A1 represents the amplitude of the signal, ω represents the angular frequency of the signal, and t represents time. However, in other implementations, the sensor DAC 114 may configured to output other signals having other waveform characteristics, such as signals having square waveform characteristics, and so forth.

The touch panel sensor 102 includes a sensor 118 (e.g., a capacitive sensor) having a resistor (R) 119 serially coupled to a mutual capacitor (Cm) 121. The sensor 118 is configured to detect capacitive changes caused by a user touching the panel (e.g., touch event capacitance (C_{Δ})). While only a single resistor and capacitor is shown, it is understood that the sensor 118 may include additional resistors, capacitors, other suitable capacitive sensing circuitry, combinations thereof, and so forth, according to the requirements of the system 100. The output of the sensor 118 is coupled to the output of the offset cancellation module 106 and the input of the measuring module 108 at the node (N1) 113. As shown, node (N1) 113 is also coupled to the inverting terminal 123 of an operational amplifier (Amp) 125 and the integrating capacitor (Cᵢₙₜ) 127 of the measuring module 108. While only a single sensor 108 is shown, the touch panel sensor 102 may include a plurality of sensors 118 in accordance with the requirements of the system 100.

In one or more implementations, the measuring module 108 includes an integrating capacitor (Cᵢₙₜ) 127 coupled across the inverting terminal 123 and the output 129 of an operational amplifier (Amp) 125. The non-inverting terminal 131 of the amplifier (Amp) 125 is coupled to a reference voltage (V_{ref}) and the output of the amplifier (Amp) 125 is coupled to the input of the ADC 110 so that the ADC 110 receives the output voltage (Vₒ) from the measuring module 108. While FIG. 1B illustrates node (N1) 113 as connected to the inverting terminal 123, it is contemplated that in some embodiments the non-inverting terminal 131 may instead be coupled to the node (N1) 113 (and the inverting terminal 123 connected to the reference voltage (V_{ref})). In other implementations, the measuring module 108 may comprise circuitry capable of converting received charge to a corresponding output voltage having a desired gain. In an implementation, the integrating capacitor (Cᵢₙₜ) 127 has a capacitance of less than one hundred pico-Farads (100 pF) and is preferably in the range of about fifteen to about twenty-five pico-Farads (15 to 25 pF). In a specific implementation, the integrating capacitor (Cᵢₙₜ) 127 has a capacitance of about twenty pico-Farads (20 pF). However, it is understood that the capacitance of the integrating capacitor (Cᵢₙₜ) 127 may vary according to the requirements of the system 100.

In one or more implementations, the offset cancellation driver 112 comprises an offset cancellation DAC 120 coupled to a buffer 122, wherein the buffer 122 buffers the offset cancellation signal produced by the offset cancellation DAC 120 and outputs the offset cancellation signal to the offset cancellation capacitor (C_{off}) 133, of the offset cancellation module 106 in order to drive the offset cancellation capacitor (C_{off}) 133. In embodiments, the offset cancellation DAC 120 is configured to generate a signal having waveform characteristics that can be represented by the following equation:

A2·sin(ωt+φ), EQN. 2

where (A2) represents the amplitude of the signal, ω represents the angular frequency of the signal, t represents the time, and φ represents the phase of the signal. In another implementation, the offset cancellation DAC 120 may be configured to output signals having other waveform characteristics (e.g., signals having square waveform characteristics, and so forth).

The offset cancellation module 106 comprises the offset cancellation capacitor (C_{off}) 133, which is coupled to the output of the sensor 118 and the input of measuring module 108 at the node (N1) 113, which is then coupled to the inverting terminal 123 of the amplifier (Amp) 125 and the integrating capacitor (Cᵢₘₜ) 127 of the measuring module 108. In one or more implementations, the offset cancellation capacitor (C_{off}) 133 may comprise a digitally controlled variable capacitor such as a capacitive digital-to-analog converter. For example, the offset cancellation capacitor (C_{off}) 133 may range in capacitive values from about eight pico-Farads (8 pF) to less than one pico-Farads (<1 pF). In one or more implementations, the offset cancellation module 106 may comprise multiple capacitors and/or variable capacitors and associated circuitry so that the value of the capacitance charge/voltage output by the offset cancellation module 106 can be adjusted. However, it is contemplated that the offset cancellation module 106 may comprise other devices capable of producing adjustable capacitance. The offset cancellation capacitor (C_{off}) 133 and the integrating capacitor (Cᵢₙₜ) 127 may have capacitances that are multiples of a chosen unit capacitor to form good matching between them. For example, if the chosen unit capacitor has a capacitance of two pico-Farads (2 pF), capacitor (C_{off}) 133 and (Cᵢₙₜ) 127 may have values of sixty pico-Farads (60 pF) and twenty pico-Farads (20 pF), respectively. In another example, the offset capacitor (C_{off}) 133 and the integrating capacitor (Cᵢₙₜ) 127 may comprise unrelated capacitive values.

The ADC 110 is coupled to the output of the measuring module 108 so that the voltage (Vₒ) output by the operational amplifier (Amp) 125 is converted from an analog voltage value to a digital voltage value (Vₒᵤₜ). The ADC 110 may also be coupled to control logic to sample the digital output (Vₒᵤₜ) of the ADC 110 and select different offset cancellation module 106 capacitances based on the sampled values.

Both the capacitance of the offset cancellation module 106 and the amplitude (A2) and/or phase (φ) of the signal output by the offset cancellation driver 112 may be adjusted to at least substantially cancel (e.g., offset) the static sensor capacitance (Cₛ) (and any parasitic capacitance) of the mutual capacitor (Cₘ) 127 at the node (N1) 113. This cancellation may enable the measuring module 108 to measure the touch event capacitance (C_{Δ}) on the mutual capacitor (Cₘ) 121 caused by a touch event.

The ability to adjust the amplitude (A2) and phase (φ) of the offset cancellation signal allows the system 100 to at least partially cancel out the static sensor capacitance (Cₛ) even if the offset cancellation module 106 is unable to exactly match the static capacitance value. For example, amplitude (A2) and the phase (φ) of the offset cancellation signal may be adjusted to at least substantially cancel (e.g., a majority part of) the sensor capacitance (Cₛ). Accordingly, the noise margin (e.g., noise headroom) of the system 100 is maximized allowing a larger gain to be used and a better signal to noise ratio to be furnished. Further, a smaller integration capacitor (Cᵢₙₜ) 127 may be used since the integration capacitor can be configured for the values of the touch event capacitance (C_{Δ}) without saturating the integrating capacitor (Cᵢₙₜ) 127, and thereby altering the output voltage (Vₒ). However, without cancellation, the integration capacitor (Cᵢₙₜ) 127 may require a sufficiently large capacitance value to accommodate not only the value of the touch event capacitance (C_{Δ}), but also the value of the static sensor capacitance (Cs), and the parasitic capacitances together. Furthermore, the ability to utilize a smaller integration capacitor (Cᵢₙₜ) 127 increases the resolution of the measuring module 108 because larger capacitors are unable to measure smaller charges received from the sensor 118. Moreover, improved dynamic range of the touch panel sensor system 100 is provided because both small and large capacitances can be measured by the system 100 as their capacitance offset values are at least substantially canceled by the offset cancellation capacitor (C_{off}) 133.

Example Methods

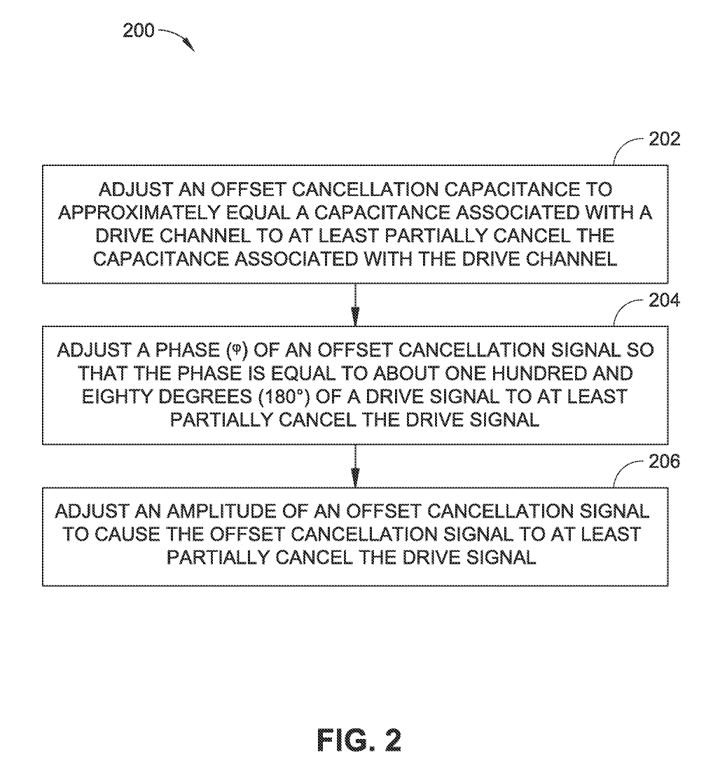

FIG. 2 illustrates a method 200 for dynamically adjusting a touch panel sensor system to cancel touch panel offset according to an example implementation of the present disclosure. The offset cancellation module capacitance of the offset cancellation module is adjusted until the value of the offset cancellation capacitance approximately equals the capacitance associated with the drive channel at the node (N1) to at least partially cancel the capacitance associated with the drive channel (Block 202). In one or more implementations, the control module 109 causes the offset cancellation module 106 to adjust the offset capacitance value (e.g., capacitor (C_{off})) until the value of offset cancellation capacitance is at least approximately equal to the capacitance associated with the drive channels of the system 100 at the node (N1) 113. For example, the system 100 may include multiple drive channels coupled to the node (N1) 113. In an implementation, each drive channel may include a touch panel sensor 102 and a sensor driver 104, each drive channel may include a mutual capacitor (Cₘ) 121 having a mutual capacitance value, environmental capacitances associated with each drive channel (e.g., capacitances associated with the sensor 102 and the sensor driver 104), and so forth. Thus, the capacitance value of the offset cancellation module 106 may be adjusted until the capacitance value at least partially cancels the capacitance value at the node (N1) 113. In other implementations, the control module 109 may be configured to adjust the offset cancellation module 106 based upon a determination of when the output voltage (Vₒ) of the measuring module 108, or the output voltage (Vₒᵤₜ) of the ADC 110, corresponds to zero volts (0V), or the smallest negative value (or the smallest positive value when the offset cancellation capacitance of the offset capacitor (C_{off}) 133 is adjusted at least approximately to, but not greater than, the capacitance at the node (N1) 113 (e.g., capacitance values associated with the drive channels)). For example, as shown in FIG. 1B, when the capacitance value of the offset capacitor (C_{off}) 133 becomes greater than the capacitance value at the node (N1) 113, the output voltage (Vₒ) may be approximately equal to a negative voltage and the output voltage (Vₒᵤₜ) represents a negative voltage value. In a specific implementation, the sensor 118 is controlled/monitored so that the mutual capacitance value (Cₘ) of the sensor 118 is at least approximately equal to the static sensor capacitance (Cₛ) (and any parasitic capacitances), but not the touch event capacitance (C_{Δ})

As shown in FIG. 2, the phase (φ) of the offset cancellation signal is adjusted so that the phase (φ) is equal to about one hundred and eighty degrees (180°) of the drive signal to at least partially cancel the drive signal (Block 204). In an implementation, the phase (φ) of the offset cancellation signal may be adjusted so that the phase (φ) is equal to about one hundred and eighty degrees (180°) of the phase of the drive signal, which is generated by the sensor driver 104. Thus, the phase (φ) is adjusted so that the phase (φ) is about equal to one hundred and eighty degrees (180°) of the phase of the drive signal at the output of the offset cancellation driver 112 to at least partially cancel the drive signal. In other implementations, the phase (φ) may be set to other values to provide the maximum offset of the phase of the signal (generated by the sensor driver 104) at the node (N1) 113. For example, the phase (φ) may be set to equal the phase of the drive signal plus or minus one hundred eighty degrees (±180°) at the node (N1) 113. In implementations, the frequency (ω) of the offset cancellation signal is adjusted so that the offset cancellation frequency (ω) at least substantially matches the sensor frequency (ω) of the signal generated by the sensor driver 104.

As shown in FIG. 2, the amplitude (A2) of the offset cancellation signal is adjusted to cause the offset cancellation signal to at least partially cancel the drive signal (e.g., the remaining portion of the drive signal cancelled due to the offset cancellation signal phase adjustment) (Block 206). In an implementation, the amplitude (A2) of the offset cancellation signal, which is generated by the offset cancellation driver 112, is adjusted so that the offset cancellation signal at least partially cancels the drive signal at the node (N1) 113. The amplitude (A2) may be adjusted based upon the remaining portion of the drive signal not cancelled as a result of adjusting the phase (φ) of the offset cancellation signal (see Block 204). For example, the amplitude (A2) may be adjusted so that the amplitude (A2) is approximately equal to the amplitude (A1) of the drive signal (which is generated by the sensor driver 104). In another example, the amplitude (A2) may be adjusted so that the amplitude (A2) at least partially equals (e.g., amplitude (A2) is equal to about ten percent (10%) of the amplitude (A1), amplitude (A2) is equal to about sixty percent (60%) of the amplitude (A1), and so forth) Thus, the amplitude (A2) values of the offset cancellation signals may vary according to the amount of drive signal cancelled from the phase adjustment discussed above (e.g., phase adjust discussed in block 204). In one or more implementations, the control module 109 utilizes the capacitive value of the offset cancellation module 106 (e.g., capacitance value of capacitor (C_{off}) 133, and so forth) and the phase (φ) of the offset cancellation signal to adjust the offset cancellation amplitude (A2) to reduce the output voltage (Vₒ) of the measuring module 108 and/or the output voltage (Vₒᵤₜ) of the ADC 110. For example, the amplitude (A2) of the offset cancellation signal may be adjusted until the output voltage (Vₒ) of the measuring module 108 and/or the output voltage (Vₒᵤₜ) of the ADC 110 is at least approximately zero volts (0V).

Accordingly, the offset cancellation of the environmental capacitances within the system 100 can be optimized so that the touch capacitance (C_{Δ}) is detected/measured by the measuring module 108. As described above, the adjustment of the touch panel sensor system 100 provides an increased dynamic range. For example, at least partially all of the non-touch capacitive values (e.g., environmental capacitive values) experienced by the sensors 114 may be cancelled from the measurement by the various adjustments of the offset cancellation signal, which may allow the measuring module 106 to employ a smaller integrating capacitor (e.g., capacitance (Cᵢₙₜ) 127), which enables the system 100 to be responsive to lower capacitances/voltages. In an implementation, at least substantially (e.g., a majority part of) all of the non-touch capacitive values (e.g., environmental capacitive values) experienced by the sensors 114 may be cancelled from the measurement by the various adjustments of the offset cancellation signal. Thus, the resolution and/or dynamic range of the touch panel sensor system 100 may be improved. Specifically, the touch panel sensor system 100 may have improved dynamic range due to the system 100 dynamically adjusting (e.g., via control module 109) an offset cancellation module to modify capacitive values, signal amplitude values, and signal phase values to offset environmental (e.g., parasitic) and static sensor capacitances of the sensors 118. Once the environmental and static sensor capacitances are reduced, the measuring module 108 detects/measures the touch event capacitance (C_{Δ}). As a result, the capacitance-to-voltage converter of the touch panel sensor system 100 may utilize a small integrating capacitor thereby lowering cost and improving the dynamic range and signal to noise ratio of the system 100. Additionally, the use of dedicated drivers (the sensor driver and the offset cancellation driver), arbitrary signals may be utilized to drive the respective components while maintaining efficient sensor capacitance cancelling capabilities. Additionally, noise margins (e.g., noise headroom) may be maximized to enable a better signal to noise ratio.

### CONCLUSION

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A system comprising:
a sensor configured to detect a change in capacitance associated with a touch event upon a touch panel;
a measuring module coupled to the sensor, the measuring module configured to detect a change in capacitance associated with the touch event upon the touch panel;
an offset cancellation module coupled to the sensor, the offset cancellation module configured to furnish an adjustable capacitive value for the sensor; and
an offset cancellation driver module coupled to the offset cancellation module, the offset cancellation driver module configured to generate a second signal having an adjustable waveform characteristic for driving the offset cancellation module, the offset cancellation module configured to adjust the adjustable capacitive value, and the offset cancellation driver module configured to adjust the adjustable waveform characteristic of the second signal to at least partially cancel at least one of a parasitic capacitance or a sensor capacitance associated with the sensor.

2. The system of claim 1, wherein the measuring module comprises an operational amplifier having an integrating capacitor disposed between an inverting input and an output of the operational amplifier.

3. The system of claim 1, further comprises a sensor driver module coupled to the sensor, the sensor driver module configured to generate a drive signal having a first characteristic waveform for driving the sensor.

4. The system of claim 1, wherein the measuring module is configured to generate a voltage based upon the capacitive change at the sensor.

5. The system of claim 4, further comprising a control module coupled to the offset cancellation driver module and the offset cancellation module, the control module configured to cause the offset cancellation driver module to adjust the adjustable waveform characteristic of the second signal and to cause the offset cancellation module to adjust the adjustable capacitive value of the offset cancellation module based upon the voltage generated by the measuring module.

6. The system of claim 1, wherein at least one of the sensor driver module or the offset cancellation driver module comprise a digital-to-analog converter.

7. The system of claim 1, wherein the capacitive sensor comprises a resistor serially coupled to a mutual capacitor.

8. A system comprising:
a sensor configured to detect a change in capacitance associated with a touch event upon a touch panel;
a measuring module coupled to the sensor, the measuring module configured to detect a change in capacitance associated with the touch event upon the touch panel;
an offset cancellation module coupled to the sensor, the offset cancellation module configured to furnish an adjustable capacitive value for the sensor;
an offset cancellation driver module coupled to the offset cancellation module, the offset cancellation driver module configured to generate a second signal having an adjustable waveform characteristic for driving the offset cancellation module, the offset cancellation module configured to adjust the adjustable capacitive value, and the offset cancellation driver module configured to adjust the adjustable waveform characteristic of the second signal to at least partially cancel at least one of a parasitic capacitance or a sensor capacitance associated with the sensor; and
a control module coupled to the offset cancellation driver module and the offset cancellation module, the control module configured to cause the offset cancellation driver module to adjust the adjustable waveform characteristic of the second signal and to cause the offset cancellation module to adjust the adjustable capacitive value of the offset cancellation module.

9. The system of claim 8, wherein the measuring module is an operational amplifier having an integrating capacitor disposed between an inverting input and an output of the operational amplifier.

10. The system of claim 8, a sensor driver module coupled to the sensor, the sensor driver module configured to generate a drive signal having a first characteristic waveform for driving the sensor.

11. The system of claim 8, wherein the measuring module is configured to generate a voltage based upon the capacitive change at the sensor.

12. The system of claim 11, wherein the control module is configured to cause the offset cancellation driver module to adjust the adjustable waveform characteristic of the second signal and to cause the offset cancellation module to adjust the adjustable capacitive value of the offset cancellation module based upon the voltage generated by the measuring module.

13. The system of claim 8, wherein at least one of the sensor driver module or the offset cancellation driver module comprise a digital-to-analog converter.

14. The system of claim 8, wherein the capacitive sensor is a resistor serially coupled to a mutual capacitor.

15. A method comprising:
adjusting an offset cancellation capacitance furnished by an offset module until the offset cancellation capacitance at least approximately equals a capacitance associated with a drive channel and a sensor to at least partially cancel the capacitance associated with the drive channel and the sensor, the sensor configured to detect a change in capacitance associated with a touch event upon a touch panel;
adjusting a phase of a first signal to at least approximately one hundred and eighty degrees (180°) of a phase of a second signal to at least partially cancel the second signal, the first signal generated by an offset cancellation driver module and the second signal generated by a sensor driver module of the drive channel; and
adjusting an amplitude of the first signal to a equal at least a portion of an amplitude of the second signal to at least partially cancel a remaining portion of the second signal, the remaining portion of the second signal including a portion of the second signal not cancelled by the adjustment of the phase of the first signal.

16. The method of claim 15, wherein the first signal is configured to drive the offset cancellation driver module and the second signal is configured to drive the sensor.

17. The method of claim 15, wherein at least one of the sensor driver module or the offset cancellation driver module is a digital-to-analog converter.

18. The method of claim 15, wherein the measuring module is an operational amplifier having an integrating capacitor disposed between an inverting input and an output of the operational amplifier.

19. The method of claim 15, wherein the offset cancellation module comprises a variable capacitor.

20. The method of claim 15, wherein the measuring module is configured to generate a voltage based upon the capacitive change at the sensor.
